(19) United States
(12) Patent Application Publication
(10) Pub. No.: US 2017/0153465 A1
(43) Pub. Date: Jun. 1, 2017

(54) System and Method of Visually Distinguishing an Eyewear Frame

(71) Applicants: Kimberly Jarvis, Dayton, OH (US); Charis Jarvis, Dayton, OH (US)

(72) Inventors: Kimberly Jarvis, Dayton, OH (US); Charis Jarvis, Dayton, OH (US)

(21) Appl. No.: 15/365,702

(22) Filed: Nov. 30, 2016

Related U.S. Application Data
(60) Provisional application No. 62/260,740, filed on Nov. 30, 2015.

(51) Int. Cl. G02C 11/02; B44C 1/17

(52) U.S. Cl. CPC G02C 11/02; B44C 1/1737

(57) ABSTRACT

A method of visually distinguishing an eyewear frame requires a sticker panel, an adhesive lining, and an eyewear frame. The sticker panel further comprises a plurality of visually-distinguishable portions. The method begins by removing a desired portion from the plurality of visually-distinguishable portions from the adhesive lining. The adhesive of the desired portion is exposed and readily able to fasten the desired portion to a selected piece of the eyewear frame. The method then aligns the desired portion to the selected piece of the eyewear frame so that the adhesive adheres to only the selected piece. Finally, the method adhering the desired portion to the selected piece by pressing the desired portion against the selected piece.

The current application claims priority to U.S. provisional application Ser. No. 62/260,740 filed on Nov. 30, 2015.

### FIELD OF THE INVENTION

The present invention generally relates to customizing an eyewear frame. More specifically, the present invention attaches adherable objects to the eyewear frame without damaging the exterior of the eyewear frame.

### BACKGROUND OF THE INVENTION

Because glasses are mass-produced, there is a legitimate need for a user to add personal flair which expresses their style. As time passes, different styles of glasses move in and out of popularity. Because of this it is difficult for a user to remain trendy while expressing his or her unique sense of style. Furthermore, keeping up with stylistic trends is often prohibitive of personal expression. To address this issue, glasses manufactures frequently create higher end frames which have somewhat unique accents that are not commonly seen by the general population. However even these high-end models are mass-produced and there is no guarantee of their uniqueness. Another issue with using mass-produced glasses as a tool for self-expression is the fact that a user generally has no influence in the designs which are applied to the frames. Because of this, glasses selection becomes an arduous process where a user must try on many different frames. Often the glasses chosen by a user have a preferred style but do not have the correct color or accents to truly express his or her individuality. Even with the wide variety of mass-produced frames, there is no guarantee that the user will find a pair of glasses that truly expresses his or her individuality.

The present invention addresses this concern by providing users with a means of customizing the arms of any pair of glasses. The present invention is a method of using a glasses customization system in order to visually distinguish an eyewear frame which enables a user to affix gemstones, pictures, patters, and other pieces of personal flair to his or her eyewear. The present invention enables a user to modify any pair of eyewear regardless of shape or size. To accomplish this, a plurality of resizable decorative panels can be adhered to the surface of the arms of a pair of glasses. A user only needs to select the desired pattern for the decorative panels, and then remove any excess material. Once the excess panel material is removed the user then attaches the decorative panel to the frame. This process enables a user to have a unique design on the surface of his or her glasses. Additionally, a user is able to remove or replace any decorative panel applied using the present invention.

### BRIEF DESCRIPTION OF THE DRAWINGS

FIG. 1 is a schematic view for a system of the present invention that is able to visually distinguish an eyewear frame.

FIG. 2 is a schematic view for a system of the present invention that has visually distinguished an eyewear frame.

FIG. 3 is a flowchart illustrating the overall process for the present invention.

FIG. 4 is a flowchart illustrating the process of removing a desired portion, wherein the desired portion is precut on the sticker panel.

FIG. 5 is a flowchart illustrating the process of removing a desired portion, wherein the desired portion is perimetrically perforated on the sticker panel.

FIG. 6 is a flowchart illustrating the process of removing a desired portion, wherein the desired portion is visually outlined on the sticker panel.

FIG. 7 is a flowchart illustrating the process of aligning a desired portion, wherein the desired portion is similarly shaped to the selected piece.

FIG. 8 is a flowchart illustrating the process of removing a desired portion, wherein the desired portion is an amorphous shape.

FIG. 9 is a flowchart illustrating the process of replacing a desired portion that is adhered to the eyewear frame with another desired portion.

FIG. 10 is a flowchart illustrating the process of placing another desired portion that is adhered to the eyewear frame with onto the desired portion.

### DETAIL DESCRIPTIONS OF THE INVENTION

All illustrations of the drawings are for the purpose of describing selected versions of the present invention and are not intended to limit the scope of the present invention.

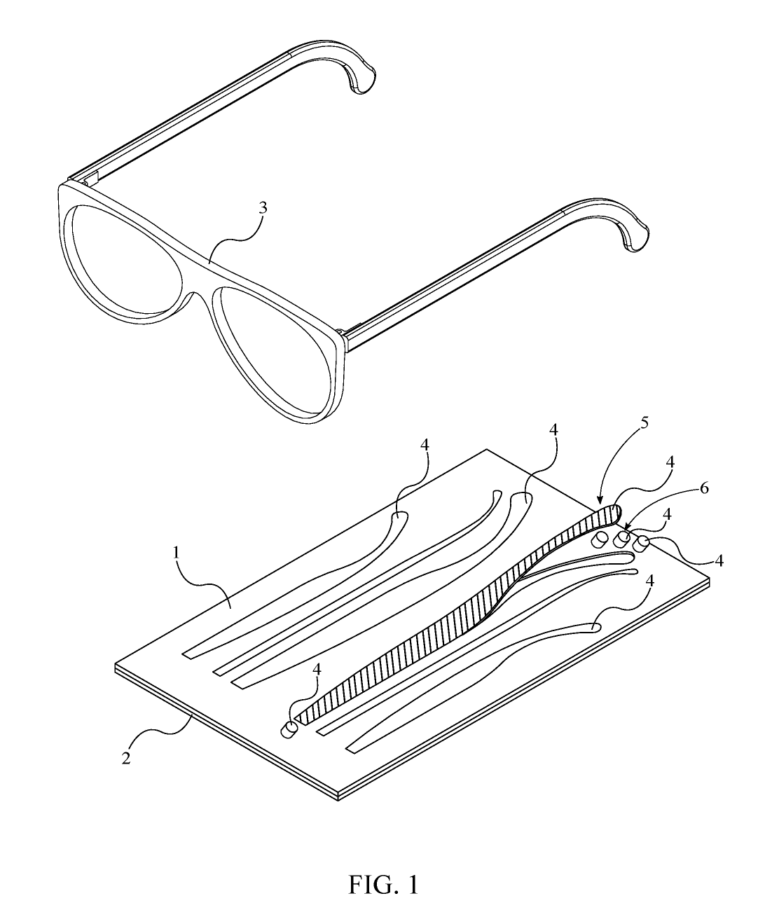

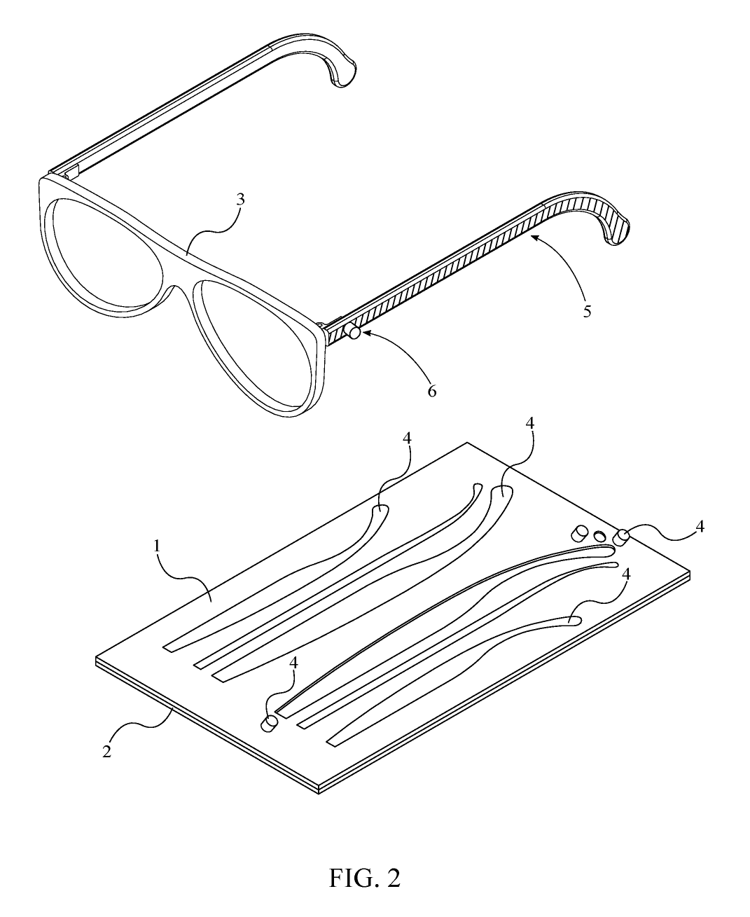

The present invention is a system and a method of visually distinguishing an eyewear frame. The present invention is used to convert a user's eyewear frame into a variety of physical appearances without damaging the existing eyewear frame. Thus, the physical system used to implement the method of the present invention includes a sticker panel 1 and an adhesive lining 2, wherein the sticker panel 1 includes a plurality of visually-distinguishable portions 4 (Step A). The present invention further includes an eyewear frame 3 (Step B). The sticker panel 1, the adhesive lining 2, and the eyewear frame 3 is shown in FIG. 1 and FIG. 2. Each of the plurality of visually-distinguishable portions 4 conceals a selected piece of the eyewear frame 3 and provides a visually-distinguishable surface that varies from that of the selected piece. The sticker panel 1 is mounted onto the adhesive lining 2 so that the adhesive of each of the visually-distinguishable portions 4 is covered by the adhesive lining 2, as shown in FIG. 1. Each of the plurality of visually-distinguishable portions 4 can be applied to the eyewear frame 3, as seen in FIG. 2. The eyewear frame 3 upholds a couple of lenses in front of the user's eyes. The couple of lenses can be, but is not limited to, prescription lenses, sunglass lenses, and fashion lenses. The user is able to remove and apply one of the visually-distinguishable portions 4 to the eyewear frame 3 in order to visually differentiate the eyewear frame 3 from its previous physical appearance.

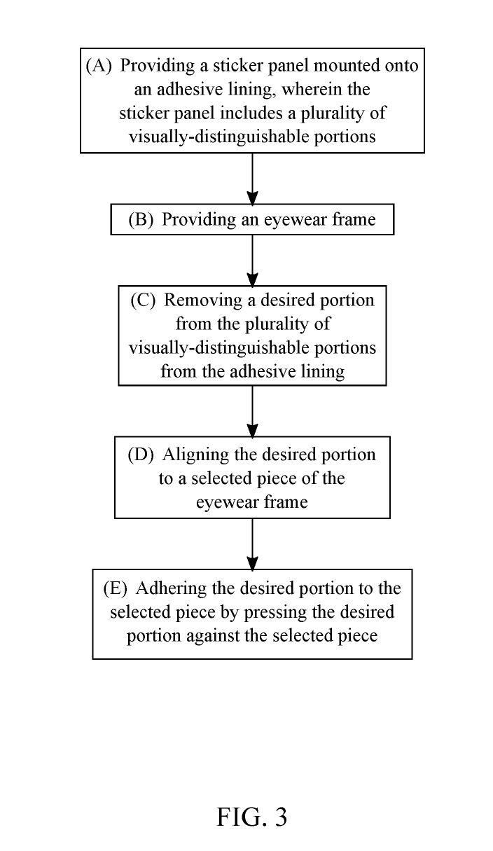

The overall process for the present invention is illustrated in FIG. 3 and includes the following steps that are implemented with the sticker panel 1, the eyewear frame 3, and the adhesive lining 2. The overall process begins by removing a desired portion 5 from the plurality of visually-distinguishable portions 4 off of the adhesive lining 2 (Step C). The adhesive enables the desired portion 5 to be fastened onto the eyewear frame 3. The desired portion 5 is aligned to a selected piece of the eyewear frame 3 (Step D) so that the desired portion 5 does not exceed past the perimeter of the eyewear frame 3 and does not expose the adhesive of the desired portion 5. The selected piece may be the entirety or a portion of the left temple, the left lens rim, the bridge, the right lens rim, or the right temple. This prevents the desired portion 5 from being improperly attached onto the selected piece so that the desired portion 5 is able to fully cover the selected piece. The desired portion 5 is adhered to the selected piece by pressing the desired portion 5 against the selected piece (Step E). The pressing of the desired portion 5 engages the adhesive of the desired portion 5 with the eyewear frame 3 and prevents the unwanted separation of the desired portion 5 and the eyewear frame 3.

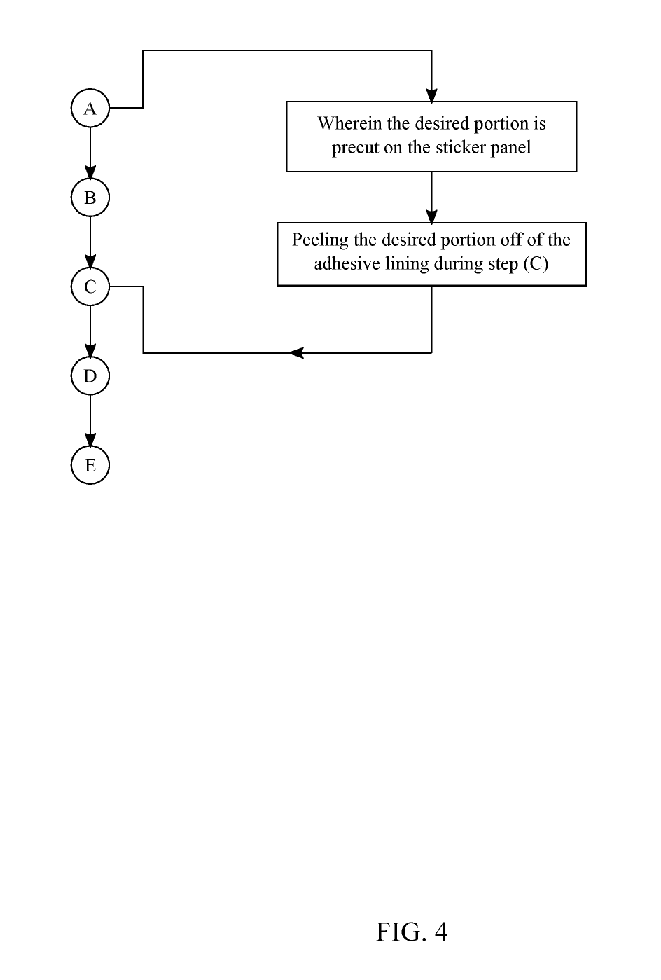

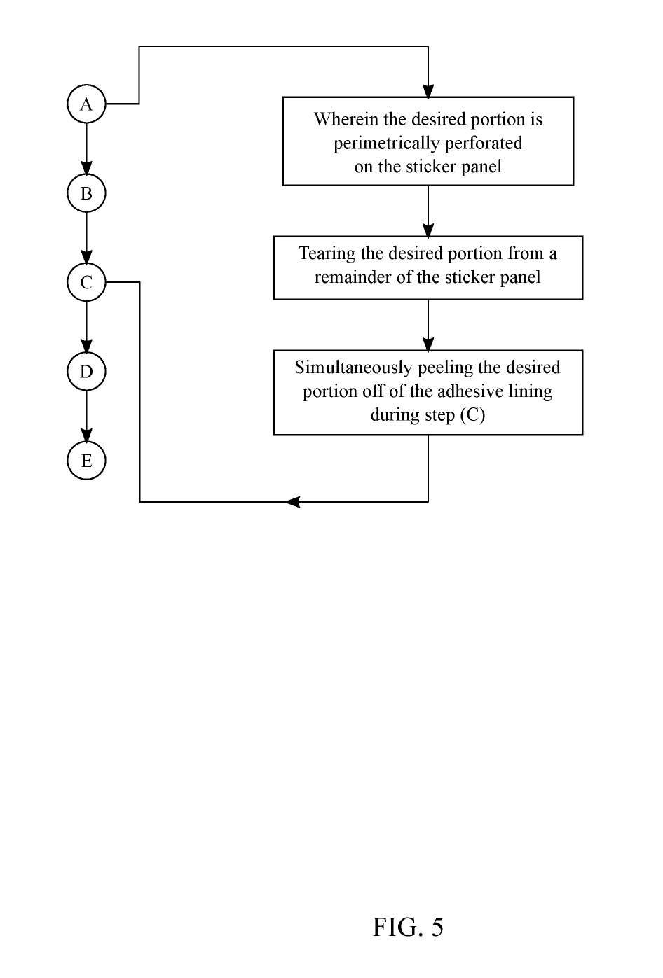

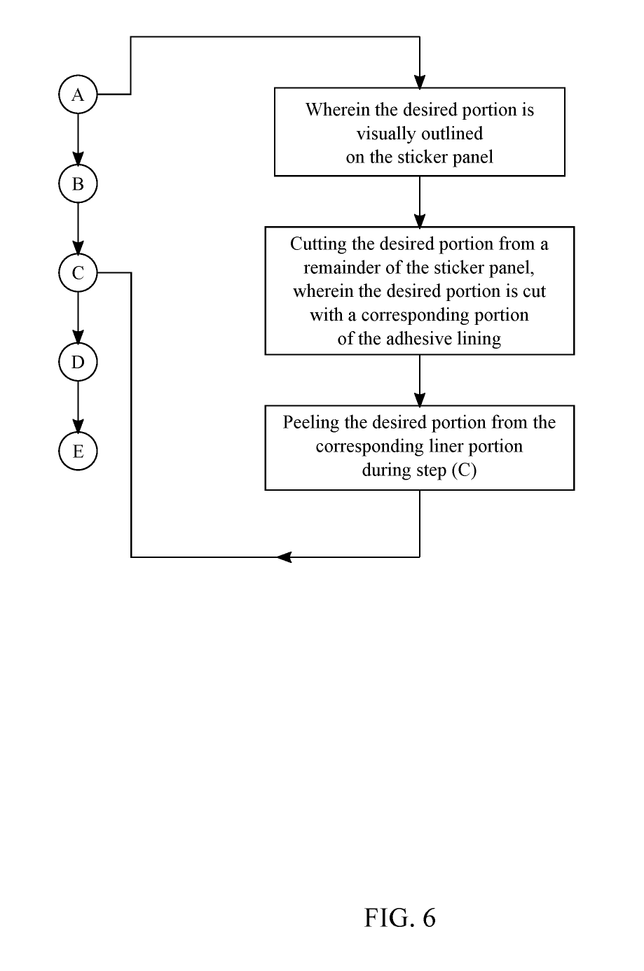

The present invention allows for different kinds of responses to step C. In one embodiment of the present invention, shown in FIG. 4, wherein the desired portion 5 is precut on the sticker panel 1, the desired portion 5 is peeled off of the adhesive lining 2 during step C. This limits the amount of tools necessary to separate the desired portion 5 from the remainder of the sticker panel 1 and the adhesive lining 2. In another embodiment of the present invention, shown in FIG. 5, the desired portion 5 is perimetrically perforated on the sticker panel 1. The desired portion 5 of this embodiment is torn from the remainder of the sticker panel 1 while being simultaneously peeled off of the adhesive lining 2 during step C. The desired portion 5 being perimetrically perforated secures the desired potion within the sticker panel 1 so that the desired portion 5 is not so easily separated from the sticker panel 1. In another embodiment of the present invention, shown in FIG. 6, the desired portion 5 is visually outlined on the sticker panel 1. The desired portion 5 is cut from the remainder of the sticker panel 1, wherein the desired portion 5 is cut with a corresponding portion of the adhesive lining 2. Scissors cut along the outline of the sticker panel 1 such that the desired portion 5 best fits within the selected piece and the adhesive lining 2 remains attached to the desired portion 5. In this embodiment, the desired portion 5 may be further customized than as suggested by the outline of the sticker panel 1. The desired portion 5 is peeled from the corresponding liner portion during step C thereby exposing the adhesive of the desired portion 5.

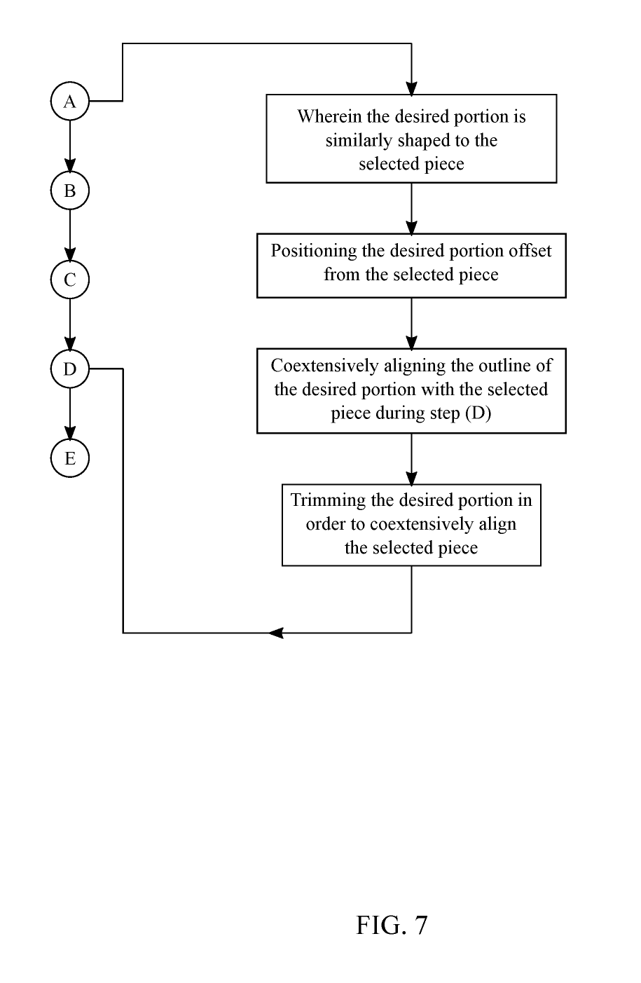

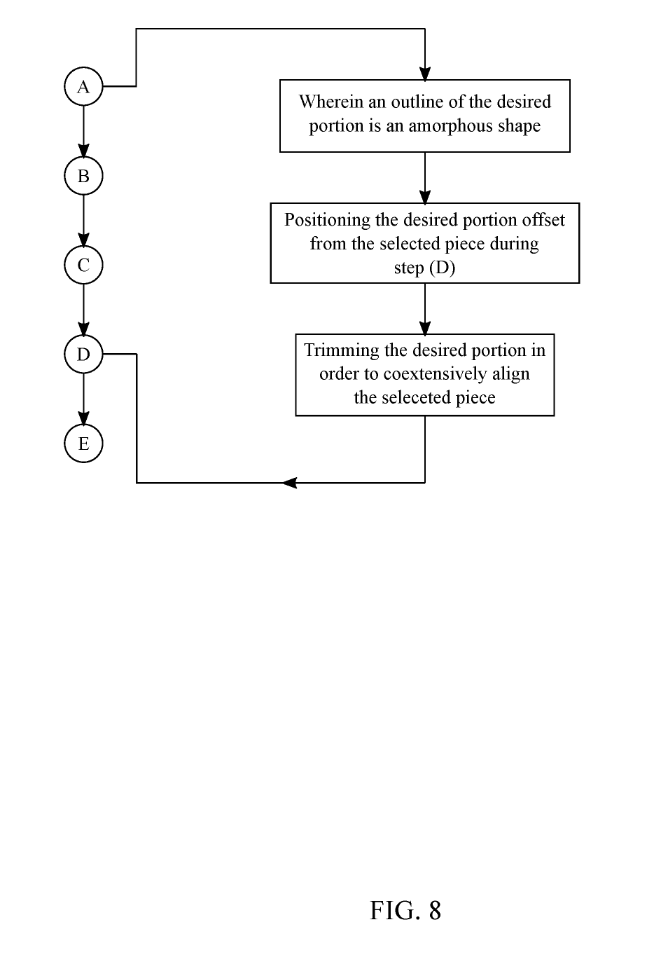

The present invention allows for different kinds of responses to step D. In one embodiment of the present invention, shown in FIG. 7, wherein an outline of the desired portion 5 is similarly shaped to the selected piece, the desired portion 5 is positioned offset from the selected piece, thereby increasing the accuracy of alignment between the desired portion 5 and the selected piece. The outline of the desired portion 5 is coextensively aligned with selected piece during step D. The coextensive alignment between the desired portion 5 and the selected piece prevents the adhesive of the desired portion 5 from adhering onto anything other than the selected piece. Furthermore, the desired portion 5 may be trimmed in order to coextensively align the selected piece as the desired portion 5 may not fit within the selected piece as outlined in the sticker panel 1. The edges of the desired portion 5 may be cut by scissors or a comparable sharpened tool so that the desired portion 5 fits within the selected piece. In another embodiment of the present invention, shown in FIG. 8, an outline of the desired portion 5 is an amorphous shape. The amorphous shape may be an outline of a gemstone, a variety of pictures, patterns, and a variety of stylistic representations. In this embodiment, the desired portion 5 is positioned offset from the selected piece during step D. The desired portion 5 may also be trimmed in this embodiment in order to coextensively align the selected piece.

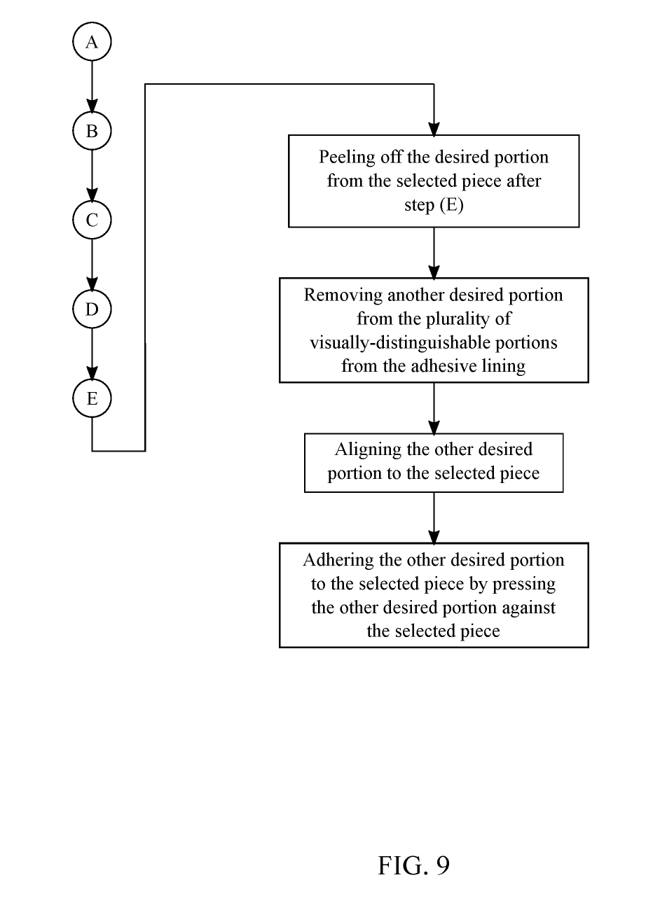

The present invention can also be configured to provide more than one variation of the physical appearance of the eyewear frame 3. As shown in FIG. 9, in order to vary the physical appearance of the eyewear frame 3 with a desired portion 5 adhered to the eyewear frame 3, the desired portion 5 is peeled off from the selected piece after step E. The selected piece is readily available for another desired portion 5. The other desired portion 5 is then removed from the plurality of visually-distinguishable portions 4 from the adhesive lining 2. The other desired portion 5 is aligned to the selected piece and adhered to the selected piece by pressing the other desired portion 5 against the selected piece, resulting in the eyewear frame 3 having more than one varied physical appearance.

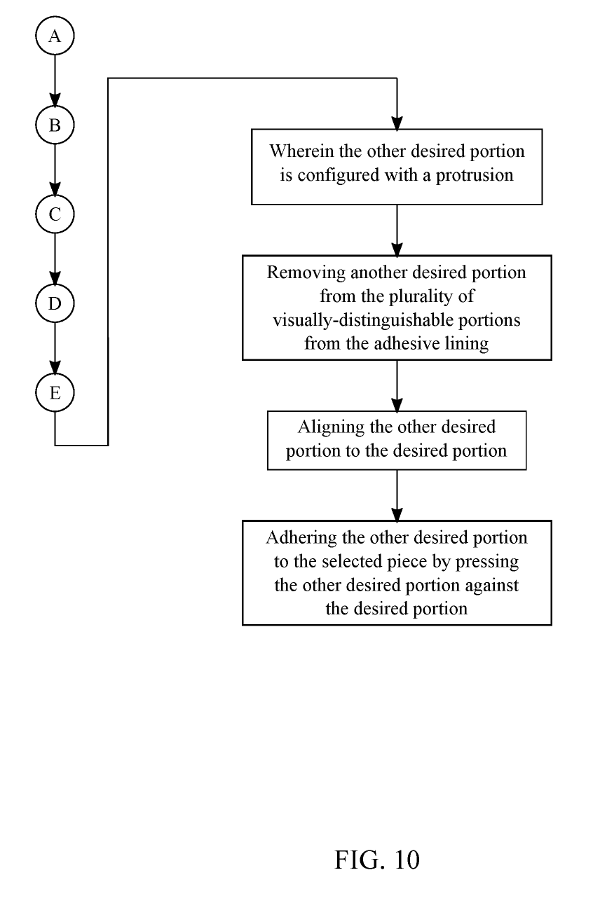

In an alternate embodiment of the present invention, the physical appearance of the eyewear frame 3 may be further varied as another desired portion 6 is removed from the plurality of visually-distinguishable portions 4 from the adhesive lining 2 after step E, as shown in FIG. 10. The other desired portion 6 is aligned to the desired portion 5. The other desired portion 6 adheres to the desired portion 5 by pressing the other desired portion 6 against the desired portion 5. The surface of the other desired portion 6 adjacent the adhesive may be a flat surface or a curved surface such that the surface adjacent the adhesive couples onto the contours of the selected piece. The preferred embodiment of the other desired portion 6 is configured with a protrusion. The protrusion can be, but is not limited to, a stud, a rhinestone, a bead, a medallion, a miniaturized key, or any other kind of decorative protruding object. The protrusion enhances the visually-distinguishable eyewear frame 3 and increases the variation of the eyewear frame 3.

The physical appearance of the eyewear frame 3 is further varied as the selected piece is a component selected from the group consisting of a left temple, a left lens rim, a bridge, a right lens rim, and a right temple. A combination of desired portions 4 that correspond to the left temple, the left lens rim, the bridge, the right lens rim, and the right temple may be selected from the sticker panel 1, resulting in a multitude of varied physical appearances.

Although the invention has been explained in relation to its preferred embodiment, it is to be understood that many other possible modifications and variations can be made without departing from the spirit and scope of the invention as hereinafter claimed.

What is claimed is:

1. A method of visually distinguishing an eyewear frame comprises the steps of:
(A) providing a sticker panel mounted onto an adhesive lining, wherein the sticker panel includes a plurality of visually-distinguishable portions;
(B) providing an eyewear frame;
(C) removing a desired portion from the plurality of visually-distinguishable portions off of the adhesive lining;
(D) aligning the desired portion to a selected piece of the eyewear frame; and
(E) adhering the desired portion to the selected piece by pressing the desired portion against the selected piece.

2. The method of visually distinguishing an eyewear frame as claimed in claim 1 comprises the steps of:
wherein the desired portion is precut on the sticker panel; and
peeling the desired portion off of the adhesive lining during step (C).

3. The method of visually distinguishing an eyewear frame as claimed in claim 1 comprises the steps of:
wherein the desired portion is perimetrically perforated on the sticker panel;
tearing the desired portion from a remainder of the sticker panel; and
simultaneously peeling the desired portion off of the adhesive lining during step (C).

4. The method of visually distinguishing an eyewear frame as claimed in claim 1 comprises the steps of:
wherein the desired portion is visually outlined on the sticker panel;
cutting the desired portion from a remainder of the sticker panel, wherein the desired portion is cut with a corresponding portion of the adhesive lining; and
peeling the desired portion from the corresponding liner portion during step (C).

5. The method of visually distinguishing an eyewear frame as claimed in claim 1 comprises the steps of:
wherein an outline of the desired portion is a similarly shaped to the selected piece;
positioning the desired portion offset from the selected piece; and
coextensively aligning the outline of the desired portion with the selected piece during step (D).

6. The method of visually distinguishing an eyewear frame as claimed in claim 5 comprises the step of:
trimming the desired portion in order to coextensively align the selected piece.

7. The method of visually distinguishing an eyewear frame as claimed in claim 1 comprises the steps of:
wherein an outline of the desired portion is an amorphous shape; and,
positioning the desired portion offset from the selected piece during step (D).

8. The method of visually distinguishing an eyewear frame as claimed in claim 5 comprises the step of:
trimming the desired portion in order to coextensively align the selected piece.

9. The method of visually distinguishing an eyewear frame as claimed in claim 1 comprises the steps of:
peeling off the desired portion from the selected piece after step (E);
removing another desired portion from the plurality of visually-distinguishable portions from the adhesive lining;
aligning the other desired portion to the selected piece; and
adhering the other desired portion to the selected piece by pressing the other desired portion against the selected piece.

10. The method of visually distinguishing an eyewear frame as claimed in claim 1 comprises the steps of:
removing another desired portion from the plurality of visually-distinguishable portions from the adhesive lining after step (E);
aligning the other desired portion to the desired portion; and
adhering the other desired portion to the desired portion by pressing the other desired portion against the desired portion.

11. The method of visually distinguishing an eyewear frame as claimed in claim 10, wherein the other desired portion is configured with a protrusion.

12. The method of visually distinguishing an eyewear frame as claimed in claim 1, wherein the selected piece is a component selected from the group consisting of: a left temple, a left lens rim, a bridge, a right lens rim, and a right temple.
